(19) United States
(12) Patent Application Publication
(10) Pub. No.: US 2015/0102016 A1
(43) Pub. Date: Apr. 16, 2015

(54) LASER METALWORKING OF REFLECTIVE METALS USING FLUX

(71) Applicant: Siemens Energy, Inc., Orlando, FL (US)

(72) Inventors: Gerald J. Bruck, Oviedo, FL (US); Ahmed Kamel, Orlando, FL (US)

(21) Appl. No.: 14/507,916

(22) Filed: Oct. 7, 2014

Related U.S. Application Data
(63) Continuation-in-part of application No. 14/341,888, filed on Jul. 28, 2014.
(60) Provisional application No. 61/859,317, filed on Jul. 29, 2013.

(51) Int. Cl. B23K 26/32; B23K 35/34; B23K 35/36; B23K 25/00

(52) U.S. Cl. CPC B23K 26/3206; B23K 25/00; B23K 35/34; B23K 35/3602; B23K 35/3607; B23K 35/3605
USPC 219/73.2

(57) ABSTRACT

Methods for laser processing of reflective metals. A reflective metal (2) is heated by applying a laser beam (6) to a layer of flux (4) in contact with the reflective metal, in which the flux is a powdered flux composition. The laser beam (38) may be applied to a powdered flux composition (36) such that thermal energy absorbed from the laser beam is transferred to a reflective-metal filler material (32) situated on a support material (30), and the powdered flux composition and the reflective-metal filler material melt to form a melt pool (40) which solidifies to form a metal layer (42) covered by a slag layer (44).

This application is a continuation-in-part of U.S. application Ser. No. 14/341,888 (attorney docket number 2013P12177US01), which was filed on 28 Jul. 2014 and claims benefit of 29 Jul. 2013 filing date of U.S. provisional application No. 61/859,317 (attorney docket number 2013P12177US), both of which are incorporated herein by reference.

### FIELD OF THE INVENTION

This application relates to materials technology in general and more specifically to laser processing of metals such as copper, aluminum and silver, which are light reflective and therefore not readily melted by certain laser frequencies.

### BACKGROUND OF THE INVENTION

The use of energy beams as a heat source for welding is well known. However, the effectiveness of lasers as a heat source can sometimes be limited by the optical properties of the material. Whereas ferrous metals readily absorb light within a wide range of wavelengths amenable to current laser welding technologies, more reflective metals such as copper, aluminum and silver often require the use of special lasers to enable laser processing.

This problem is illustrated in FIG. 1 which plots the optical absorptivity versus photon wavelength for a variety of common metals. As shown in curves 8 and 10, iron and steel readily absorb photons emitted by a number of commonly employed laser sources including 503 nm “green” Nd:YAG lasers 12, 1.06 μm Nd:YAG lasers 14, 5.4 μm CO lasers 16, and 10.6 μm CO₂ lasers 18. However, the absorptivity plots for the metals silver 2, copper 4 and aluminum 6 show that these metals fail to significantly absorb photons with wavelengths greater than about 1 μm.

As shown in the plot for silver 2, this metal only absorbs a small fraction of light emitted by a “green” Nd:YAG laser 12 (503 nm). This is a very serious limitation on the use of laser heating to process silver, because “green” Nd:YAG lasers can only deliver a fraction of the power available using higher-frequency lasers such as CO lasers 16 and CO₂ lasers 18. The plot for copper 4 shows that this metal readily absorbs light emitted by a “green” Nd:YAG laser 12 (503 nm), but only poorly absorbs 1.06 μm Nd:YAG lasers 14 and almost totally reflects light from the more powerful CO and CO₂ lasers 16,18. The plot for aluminum 6 shows that this metal only absorbs modest amounts of light from 503 nm “green” Nd:YAG and 1.06 μm Nd:YAG lasers.

Copper is an especially challenging metal to process using laser heating for a number of reasons. First, as explained above copper only absorbs photons from “green” Nd:YAG lasers 12, which are much weaker than higher-frequency sources such as the CO and CO₂ lasers 16,18. This severely limits the surface area and thickness of copper materials that can be processed using laser heating. A second related problem with copper is that this metal exhibits a high thermal conductivity such that laser processing requires high power levels that are difficult (and sometimes impossible) to attain using “green” Nd:YAG lasers 12. Another problem is that copper in a melted state has a very low viscosity as compared to other metals. Consequently, copper materials processed using laser melting and solidification often contain mechanical imperfections due to turbulence and irregularities within the intermediate weld pool.

Meanwhile, the industrial demand for complex components made of reflective metals such a copper, aluminum and silver continues to rise as these materials are often integral components within electrical and mechanical devices of increasingly smaller size.

### BRIEF DESCRIPTION OF THE DRAWINGS

The invention is explained in the following description in view of the drawings that show:

FIG. 1 is a chart plotting photon absorptivity versus wavelength for a number of different metals.

FIG. 2 illustrates one embodiment of the present invention in which the surface of a reflective metal substrate is melted by applying a laser beam to a powdered flux layer.

FIG. 3 illustrates another embodiment of the present invention in which a filler material containing a reflective metal is melted by applying a laser beam to a powdered flux layer.

### DETAILED DESCRIPTION OF THE INVENTION

The present Inventors have recognized that a need exists to discover methods and materials allowing reflective metals to be laser processed using a wider variety of laser sources than was previously possible. Ideal methods and materials would enable metals such as copper, aluminum and silver to be heated with laser energy and processed in a highly controllable manner using both lower power lasers (e.g., 503 nm and 1.06 μm Nd:YAG lasers) and higher power lasers (e.g., 1.06 μm ytterbium fiber, 5.4 μm CO and 10.6 μm CO₂ lasers), to form metal products containing fewer chemical and mechanical imperfections. Such methods and materials would preferentially allow laser processing of reflective metals under atmospheric conditions enabling both small scale and large scale manufacturing and repair of metallic components having intricate structural features.

The term “reflective metals” is used herein in a general sense to describe metals (e.g., copper, aluminum and silver) which exhibit low absorption of photons (e.g., having an absorptivity of less than 10% at the frequency of the photons) emitted from high-power laser sources emitting energy at 1 μm or more, such as 1.06 μm ytterbium fiber, 5.4 μm CO lasers and 10.6 μm CO₂ lasers. The term “metal” is used herein in a general sense to describe pure metals as well as alloys of metals.

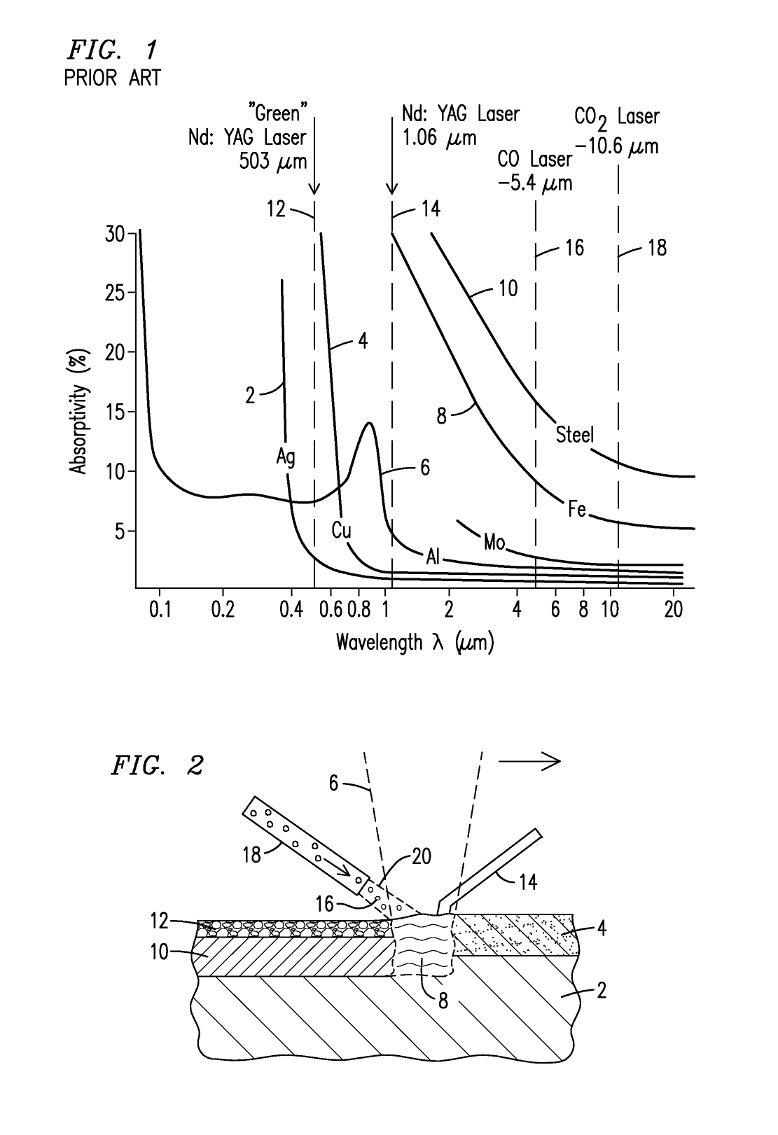

FIG. 2 illustrates one embodiment of the present disclosure in which a laser beam 6 is applied to a layer 4 of a flux composition which is situated on the surface of a reflective metal substrate 2. The laser beam could be emitted, for example, from a CO₂ laser source (10.6 μm) which would not be expected to efficiently heat the reflective metal substrate 2 due to the high reflectance of the reflective metal. In the embodiment of FIG. 2, however, the use of the layer 4 of the flux composition leads to a relatively rapid and controllable melting of both the flux layer 4 and an upper portion of the reflective metal substrate 2 to form a melt pool 8 containing molten elements of both the reflective metal and the flux composition. Following melting with the laser beam 6, the melt pool is then allowed to cool and solidify to form a resulting metal layer 10 covered by the slag layer 12.

The laser beam 6 may be a continuous laser beam, a pulsed laser beam, one or more circular laser beams, a scanned laser beam (scanned one, two or three dimensionally), an integrated laser beam or a diode laser beam. The laser beam 6 may be a single laser beam or multiple laser beams. Suitable laser beams 6 include lower power lasers (e.g., 503 nm and 1.06 μm Nd:YAG lasers) and higher power lasers (e.g., 1.06 μm ytterbium fiber, 5.4 μm CO and 10.6 μm CO₂ lasers).

The flux layer 4 and the slag layer 12 provide a number of beneficial functions that enable the process of FIG. 2 and also improve the chemical and mechanical properties of the resulting metal layer 10.

First, the flux layer 4 and the slag layer 12 greatly increase the proportion of laser energy delivered to the reflective metal substrate 2 as heat. This increase in heat absorption may occur due to the composition and/or form of the flux layer 4. In terms of composition the flux layer 4 may be formulated to contain at least one compound capable of absorbing laser energy at the wavelength of the laser beam 6. Increasing the proportion of the at least one laser absorptive compound causes a corresponding increase in the amount of laser energy (as heat) applied to the flux layer 4—leading to a corresponding increase in heat applied to the reflective metal substrate 2 (presumably via conduction heat transfer). Upon melting of the flux to form a molten slag blanket over the underlying molten metal substrate, advantageous absorptivity of the molten slag replaces inferior absorptivity of the relatively reflective substrate. Furthermore, in some cases the laser absorptive compound could also be exothermic such that its decomposition upon laser irradiation releases additional heat.

The form of the flux composition can also effect laser absorption by altering its thickness and/or particle size. As the thickness of the layer of the flux layer 4 increases, the absorption of laser heating generally increases. Increasing the thickness of the flux layer 4 also increases the thickness of a resulting molten slag blanket, which further enhances absorption of the laser beam 6. The thickness of the flux layer 4 in methods of the present disclosure typically ranges from about 1 mm to about 15 mm. In some cases the thickness ranges from about 3 mm to about 12 mm, while in other instances the thickness ranges from about 5 mm to about 10 mm.

Reducing the average particle size of the flux composition in the flux layer 4 also causes an increase in laser energy absorption (presumably through increased photon scattering within the bed of fine particles and increased photon absorption via interaction with increased total particulate surface area). In terms of the particle size, whereas commercial fluxes generally range in average particle size from about 0.5 mm to about 2 mm (500 to 2000 microns) in diameter (or approximate dimension if not rounded), flux composition in some embodiments of the present disclosure range in average particle size from about 0.005 mm to about 0.10 mm (5 to 100 microns) in diameter. In some cases the average particle size ranges from about 0.01 mm to about 5 mm, or from about 0.05 mm to about 2 mm. In other cases the average particle size ranges from about 0.1 mm to about 1 mm in diameter, or from about 0.2 mm to about 0.6 mm in diameter.

Second, the flux layer 4, gaseous products of laser interaction with the flux layer 4, and the slag layer 12 all function to shield both the region of the melt pool 8 and the solidified (but still hot) metal layer 10 from the atmosphere both at the surface of the melt pool and in the region downstream of the laser beam 6. The slag floats to the surface to separate the molten or hot metal from the atmosphere, and the flux composition may be formulated to produce at least one shielding gas as described below—thereby avoiding or minimizing the use of inert gases, sealed chambers (e.g., vacuum chambers) and other specialized devices for excluding air. In some embodiments requiring deeper penetration and higher levels of heating, the flux composition is formulated not to contain a shielding agent. This reduces or prevents reaction of reflective metals such as aluminum with potentially-reactive shielding gases like carbon monoxide (CO) and carbon dioxide (CO₂). Such embodiments may employ a thicker flux layer 4 such that the resulting thicker slag layer 12 more effectively excludes atmospheric reactants like oxygen and nitrogen.

Shielding agents include metal carbonates such as calcium carbonate (CaCO₃), aluminum carbonate (Al₂(CO₃)₃), dawsonite (NaAl(CO₃)(OH)₂), dolomite (CaMg(CO₃)₂), magnesium carbonate (MgCO₃), manganese carbonate (MnCO₃), cobalt carbonate (CoCO₃), nickel carbonate (NiCO₃), lanthanum carbonate (La₂(CO3)₃) and other agents known to form shielding and/or reducing gases (e.g., CO, CO₂, H₂).

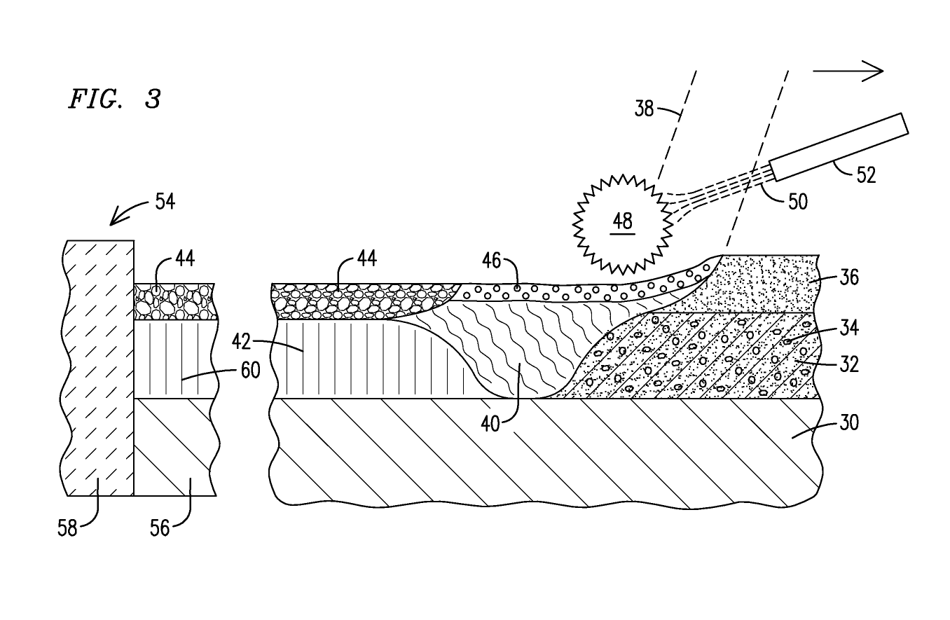

Third, the molten slag blanket and the slag layer 12 act as an insulation layer that allows the resulting metal layer 10 to cool slowly and evenly, thereby reducing residual stresses that can contribute to post weld cracking, and reheat or strain age cracking. Such slag blanketing over and adjacent to the deposited metal layer 10 can further enhance heat conduction towards the reflective metal substrate 2 which in some embodiments can promote directional solidification to form elongated (uniaxial) grains in the resulting metal layer 10 (see, e.g., the columnar grains 60 in FIG. 3).

Fourth, the molten slag blanket and the slag layer 12 help to shape and support the melt pool 8 to keep it close to a desired height/width ratio (e.g., a 1/3 height/width ratio). This shape control and support further reduces solidification stresses that could otherwise be imparted to the resulting metal layer 10.

Fifth, the flux layer 4 and the slag layer 12 provide a cleansing effect for removing trace impurities that contribute to inferior properties. Such cleaning may include deoxidation of the melt pool 8. Because the flux layer 4 is in intimate contact with the reflective metal substrate 2, and with added filler material in solid or powder form (if used), it is especially effective in accomplishing this function.

Scavenging agents include metal oxides and fluorides such as calcium oxide (CaO), calcium fluoride (CaF₂), iron oxide (FeO), magnesium oxide (MgO), manganese oxides (MnO, MnO₂), niobium oxides (NbO, NbO₂, Nb₂O₅), titanium oxide (TiO₂), zirconium oxide (ZrO₂), and other agents known to react with detrimental elements such as sulfur and phosphorous and elements known to produce low melting point eutectics to form low-density byproducts expected to “float” into a resulting slag layer.

Additionally, the flux composition of the flux layer 4 may be formulated to compensate for loss of volatilized or reacted elements during processing or to actively contribute elements to the deposit that are not otherwise provided by the reflective metal substrate 2.

Vectoring agents include titanium, zirconium, boron and aluminum containing compounds and materials such as titanium alloys (Ti), titanium oxide (TiO₂), titanite (CaTiSiO₅), aluminum alloys (Al), aluminum carbonate (Al₂(CO₃)₃), dawsonite (NaAl(CO₃)(OH)₂), borate minerals (e.g., kernite, borax, ulexite, colemanite), nickel titanium alloys (e.g., Nitinol), niobium oxides (NbO, NbO₂, Nb₂O₅) and other metal-containing compounds and materials used to supplement molten alloys with elements. Certain oxometallates as described below can also be useful as vectoring agents.

In some embodiments, additional elements and/or particles may also be provided by adding them directly into the melt pool 8. For example, another embodiment illustrated in FIG. 2 involves directly injecting particles 16 into the melt pool 8 by propelling these particles 16 through an injection nozzle 18 using a jet gas 20 such as helium, nitrogen or argon. In such cases the resulting metal layer 10 may be in the form of a dispersion strengthened alloy having improved mechanical strength, wear resistance and/or corrosion resistance relative to the reflective metal substrate 2. Particles 16 may include strengthening particles such as metal oxides, metal carbides and metal nitrides.

Alternatively, or in addition, in some embodiments supplemental elements may added to the melt pool 8 using an alloy feed material 14 as shown in FIG. 2. The feed material 14 may be in the form of a wire or strip that is fed or oscillated towards the melt pool 8 and is melted by the laser beam 6 to contribute to the melt pool 8. The feed material 14 may contain, in addition to the supplemental elements, the same or different flux composition (e.g., by way of flux cored wire) to that contained in the flux layer 4. If desired, the feed material 14 may be pre-heated (e.g., electrically) to reduce overall energy required from the laser beam 6.

FIG. 3 illustrates another embodiment of the present disclosure in which a laser beam 38 is applied to a flux layer 36 which is situated above (and partially or fully covers) a powdered filler material 32 which is placed on a surface of a support material 30. The powdered filler material 32 contains a reflective metal 34. Heat energy from the laser beam 38 causes melting of the flux layer 36 and the filler material 32 to form a melt pool 40 which, upon cooling, solidifies to form a deposited metal layer 42 covered by a slag layer 44. Alternatively, the flux and powdered metal may be mixed together and pre-placed or fed over the substrate. Still alternatively, the flux and metal may be prepared in the form of conglomerate particulate containing both flux and metal and preplaced or fed over the substrate.

Alternatively, the filler material 32 and/or the flux layer 36 may be contained within a preform structure having at least one compartment enabling greater control in the placement and deposition of the contained material. In one such embodiment, for example, the filler material 32 is contained within a lower compartment and the flux layer 36 is contained within an upper compartment, said compartments being attached together to form an integral preform structure. The preform structure may itself be made of constituents contributing to fluxing function. The reflective metal of such a preform may be constrained in a distribution that defines a shape of a layer or slice of a component subject to repair or additive fabrication. The compartments of such preforms are generally constructed of walls and a sealed periphery, in which the walls may be sheets of any type (such as fabric, film, or foil that retains the contents) and the periphery may include a non-metallic, non-melting, laser blocking material (such as graphite or zirconia).

The support material 30 may be in the form of a metallic substrate (e.g., a reflective metal substrate as described above) or may be in the form of a fugitive support material. In cases in which the support material 30 is a metallic substrate, the deposited metal layer 42 is a cladding layer bonded to the surface of the metallic substrate. In cases in which the support material 30 is a fugitive support material, the fugitive support material can be later removed from the deposited metal layer 42 to form an object containing the reflective metal 34. “Fugitive” means removable after formation of the deposited metal layer 42, for example, by direct (physical) removal, by a mechanical process, by draining, by fluid flushing, by chemical leaching and/or by any other process capable of separating the fugitive support material 30 from the deposited metal layer 42. Any high-temperature material or structure capable of providing support and then being removable after the formation of the deposited metal layer 42 may serve as the fugitive support material 30. In some embodiments the fugitive support material 30 may be in the form of a refractory container or bed of at least one material selected from a metal, a metallic powder, a metal oxide powder, a ceramic powder and a powdered flux material.

In some embodiments heat provided by the laser beam 38 can be modulated by employing a plasma suppression gas 50 to partially displace a laser-generated plasma 48 that may be formed over the laser focal point. Depending upon a number of factors including the composition and form (e.g., thickness) of the flux layer 36, as well as the power, speed and wavelength of the laser beam 38, a plasma 48 may be produced due to ionization of at least one component in the flux composition. Such a plasma 48 may reduce the thermal energy delivered to the filler material 32 by absorbing (and thus blocking) the laser beam 38 above the melt pool 40. Use of a plasma suppression gas 50 can increase this absorption of the laser beam 38—thus indirectly increasing heating of the filler material 32—by shifting the position of the plasma 48 such that a larger portion of the laser beam 38 impacts the flux layer 36 and/or melt pool 40, as shown in FIG. 3. In FIG. 3 the plasma suppression gas 50 is propelled into the plasma 48 through a nozzle 52, such that the velocity and trajectory of the plasma suppression gas 50 controls the displacement of the plasma 48. Whereas FIG. 3 illustrates an embodiment in which the plasma suppression gas 50 displaces the plasma 48 in a direction opposite to the movement of the laser beam 38 (i.e., towards the left), in other embodiments the plasma 48 may be displaced in an “upstream” direction relative to the movement of the laser beam 48 (i.e., to the right in FIG. 3). Suitable plasma suppression gases 50 include inert gases such as helium, nitrogen and argon. To the extent that the plasma is displaced upstream or downstream of the process location, the plasma energy provides radiant pre-heating or post-heating (respectively) of the flux 36 or slag 44 (respectively),

Reflective metals produced by methods of the present disclosure may also benefit from an ability to control to a certain extent the grain structure of the deposited metal layer 42 through directional solidification. FIG. 3 also depicts the optional use of a solidification mold 54 (left-hand portion shown) containing a mold bottom portion 56 and a mold side portion 58. Selecting, for example, refractory materials of relatively low or high thermal conductivity allows directional control of heat transfer during cooling of the melt pool 40—such that the resulting deposited metal layer 42 may contain either uniaxial (columnar) or equiaxed grain structures. In the non-limiting illustration of FIG. 3, for example, the mold bottom portion 56 may be constructed of a material of high thermal conductivity (e.g., graphite) and the mold side portion 58 may be constructed of a material having a low thermal conductivity (e.g., zirconia), which arrangement causes directional solidification to produce uniaxial grains 60 oriented perpendicular to the plane of the mold bottom portion 56. By controlling the thermal conductivity of the bottom and side portions 56, 58 of the refractory solidification mold 54, the grain structure of the deposited metal layer 42 can be customized and varied. Directional solidification can also be affected by employing at least one chill plate (not shown in FIG. 3) situated to contact the mold bottom portion 56 and/or the mold side portion 58. Heating plates may also be situated on the bottom and/or side portions of the solidification mold 54 to adjust the direction of heat transfer during cooling of the melt pool 40.

FIG. 3 also depicts another optional embodiment in which the flux layer 36 and/or the filler material 32 are formulated to contain a shielding agent that decomposes or otherwise reacts upon heating to form at least one shielding gas 46 which protects the melt pool 40 and/or the deposited metal layer 42 from atmospheric reactants such as oxygen and nitrogen. In some embodiments the presence of a shielding gas 46 enables processes of the present disclosure to be carried out under an oxygen-containing atmosphere (e.g., under air) without producing chemical or mechanical imperfections (i.e., inclusions and cracking) in the deposited metal layer 42. Many embodiments in which the reflective metal 34 is a reactive metal such as aluminum can benefit from the presence of a shielding agent. Compounds that may be used as the shielding agent include metal carbonates which decompose upon heating to form carbon monoxide (CO) and carbon dioxide (CO₂).

Flux compositions of the present disclosure may contain at least one of: (i) a metal oxide; (ii) a metal halide; (iii) a metal oxometallate; and (iv) a metal carbonate.

Suitable metal oxides include compounds such as Li₂O, BeO, B₂O₃, B₆O, MgO, Al₂O₃, SiO₂, CaO, Sc₂O₃, TiO, TiO₂, Ti₂O₃, VO, V₂O₃, V₂O₄, V₂O₅, Cr₂O₃, CrO₃, MnO, MnO₂, Mn₂O₃, Mn₃O₄, FeO, Fe₂O₃, Fe₃O₄, CoO, Co₃O₄, NiO, Ni₂O₃, Cu₂O, CuO, ZnO, Ga₂O₃, GeO₂, As₂O₃, Rb₂O, SrO, Y₂O₃, ZrO₂, NiO, NiO₂, Ni₂O₅, MoO₃, MoO₂, RuO₂, Rh₂O₃, RhO₂, PdO, Ag₂O, CdO, In₂O₃, SnO, SnO₂, Sb₂O₃, TeO₂, TeO₃, Cs₂O, BaO, HfO₂, Ta₂O₅, WO₂, WO₃, ReO₃, Re₂O₇, PtO₂, Au₂O₃, La₂O₃, CeO₂, Ce₂O₃, and mixtures thereof, to name a few.

Suitable metal halides include compounds such as LiF, LiCl, LiBr, LiI, Li₂NiBr₄, Li₂CuCl₄, LiAsF₆, LiPF₆, LiAlCl₄, LiGaCl₄, Li₂PdCl₄, NaF, NaCl, NaBr, Na₃AlF₆, NaSbF₆, NaAsF₆, NaAuBr₄, NaAlCl₄, Na₂PdCl₄, Na₂PtCl₄, MgF₂, MgCl₂, MgBr₂, AlF₃, KCl, KF, KBr, K₂RuCl₅, K₂IrCl₆, K₂PtCl₆, K₂PtCl₆, K₂ReCl₆, K₃RhCl₆, KSbF₆, KAsF₆, K₂NiF₆, K₂TiF₆, K₂ZrF₆, K₂PtI₆, KAuBr₄, K₂PdBr₄, K₂PdCl₄, CaF₂, CaF, CaBr₂, CaCl₂, Cal₂, ScBr₃, ScCl₃, ScF₃, ScI₃, TiF₃, VCl₂, VCl₃, CrCl₃, CrBr₃, CrCl₂, CrF₂, MnCl₂, MnBr₂, MnF₂, MnF₃, MnI₂, FeBr₂, FeBr₃, FeCl₂, FeCl₃, FeI₂, CoBr₂, CoCl₂, CoF₃, CoF₂, CoI₂, NiBr₂, NiCl₂, NiF₂, NiI₂, CuBr, CuBr₂, CuCl, CuCl₂, CuF₂, CuI, ZnF₂, ZnBr₂, ZnCl₂, ZnI₂, GaBr₃, Ga₂Cl₄, GaCl₃, GaF₃, GaI₃, GaBr₂, GeBr₂, GeI₂, GeI₄, RbBr, RbCl, RbF, RbI, SrBr₂, SrCl₂, SrF₂, SrI₂, YCl₃, YF₃, YI₃, YBr₃, ZrBr₄, ZrCl₄, ZrI₂, YBr, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, AgCl, AgF, AgF₂, AgSbF₆, AgI, CdBr₂, CdCl₂, CdI₂, InBr, InBr₃, InCl, InCl₂, InCl₃, InF₃, InI, InI₃, SnBr₂, SnCl₂, SnI₂, SnI₄, SnCl₃, SbF₃, SbI₃, CsBr, CsCl, CsF, CsI, BaCl₂, BaF₂, BaI₂, BaCoF₄, BaNiF₄, HfCl₄, HfF₄, TaCl₅, TaF₅, WCl₄, WCl₆, ReCl₃, ReCl₅, IrCl₃, PtBr₂, PtCl₂, AuBr₃, AuCl, AuCl₃, AuI, KAuCl₄, LaBr₃, LaCl₃, LaF₃, LaI₃, CeBr₃, CeCl₃, CeF₃, CeF₄, CeI₃, and mixtures thereof, to name a few.

Suitable oxometallates include compounds such as LiIO₃, LiBO₂, Li₂SiO₃, LiClO₄, Na₂B₄O₇, NaBO₃, Na₂SiO₃, NaVO₃, Na₂MoO₄, Na₂SeO₄, Na₂SeO₃, Na₂TeO₃, K₂SiO₃, K₂CrO₄, K₂Cr2O₇, CaSiO₃, BaMnO₄, and mixtures thereof, to name a few.

Suitable metal carbonates include compounds such as Li₂CO₃, Na₂CO₃, NaHCO₃, MgCO₃, K₂CO₃, CaCO₃, Cr₂(CO₃)₃, MnCO₃, CoCO₃, NiCO₃, CuCO₃, Rb₂CO₃, SrCO₃, Y₂(CO3)₃, Ag₂CO₃, CdCO₃, In₂(CO₃)₃, Sb₂(CO₃)₃, C₂CO₃, BaCO₃, La₂(CO₃)₃, Ce₂(CO₃)₃, NaAl(CO₃) (OH)₂, and mixtures thereof, to name a few.

In some embodiments the flux composition contains at least two compounds selected from a metal oxide, a metal halide, an oxometallate and a metal carbonate. In other embodiments the flux composition contains at least three of a metal oxide, a metal halide, an oxometallate and a metal carbonate. In still other embodiments the flux composition may contain a metal oxide, a metal halide, an oxometallate and a metal carbonate.

When the reflective metal is a metal such as copper which forms a low viscosity melt pool it is often beneficial to formulate the flux composition to reduce the fluidity of the melt pool and/or to increase its viscosity. For example, fluidity of the molten slag can be reduced by excluding metal fluorides which can act as fluidity enhancers. Thus, in some embodiments the flux composition is formulated to exclude metal fluorides. In other embodiments the flux composition is formulated to exclude all fluoride-containing compounds.

Viscosity of the molten slag can also be increased by including at least one high melting-point metal oxide which can act as thickening agent. Thus, in some embodiments the flux composition is formulated to include at least one high melting-point metal oxide. Examples of high melting-point metal oxides include metal oxides having a melting point exceeding 2000° C.—such as Sc₂O₃, Cr₂O₃, Y₂O₃, ZrO₂, HfO₂, La₂O₃, Ce₂O₃, Al₂O₃ and CeO₂. In some non-limiting examples the flux composition is formulated to contain at least 7.5 percent by weight of zirconia relative to a total weight of the flux composition.

In one embodiment employing this approach the flux composition comprises:

(A) at least one selected from the group consisting of Sc₂O₃, Cr₂O₃, Y₂O₃, ZrO₂, HfO₂, La₂O₃, Ce₂O₃, Al₂O₃ and CeO₂; and

(B) at least one of:
(i) a metal oxide selected from the group consisting of Li₂O, BeO, B₂O₃, B₆O, MgO, SiO₂, CaO, TiO, Ti₂O₃, VO, V₂O₃, V₂O₄, V₂O₅, CrO₃, MnO, MnO₂, Mn₂O₃, Mn₃O₄, FeO, Fe₂O₃, Fe₃O₄, CoO, Co₃O₄, NiO, Ni₂O₃, Cu₂O, CuO, ZnO, Ga₂O₃, GeO₂, As₂O₃, Rb₂O, SrO, ZrO₂, NiO, NiO₂, Ni₂O₅, MoO₃, MoO₂, RuO₂, Rh₂O₃, RhO₂, PdO, Ag₂O, CdO, In₂O₃, SnO, SnO₂, Sb₂O₃, TeO₂, TeO₃, Cs₂O, BaO, Ta₂O₅, WO₂, WO₃, ReO₃, Re₂O₇, PtO₂, Au₂O₃, and mixtures thereof;
(ii) a metal halide selected from the group consisting of LiCl, LiBr, LiI, Li₂NiBr₄, Li₂CuCl₄, LiAlCl₄, LiGaCl₄, Li₂PdCl₄, NaCl, NaBr, NaAuBr₄, NaAlCl₄, Na₂PdCl₄, Na₂PtCl₄, MgCl₂, MgBr₂, KCl, KBr, K₂RuCl₅, K₂IrCl₆, K₂PtCl₆, K₂PtCl₆, K₂ReCl₆, K₃RhCl₆, K₂PtI₆, KAuBr₄, K₂PdBr₄, K₂PdCl₄, CaBr₂, CaCl₂, CaI₂, ScBr₃, ScCl₃, ScI₃, VCl₂, VCl₃, CrCl₃, CrBr₃, CrCl₂, MnCl₂, MnBr₂, MnI₂, FeBr₂, FeBr₃, FeCl₂, FeCl₃, FeI₂, CoBr₂, CoCl₂, CoI₂, NiBr₂, NiCl₂, NiI₂, CuBr, CuBr₂, CuCl, CuCl₂, CuI, ZnBr₂, ZnCl₂, ZnI₂, GaBr₃, Ga₂Cl₄, GaCl₃, GaI₃, GaBr₂, GeBr₂, GeI₂, GeI₄, RbBr, RbCl, RbI, SrBr₂, SrCl₂, SrI₂, YCl₃, YI₃, YBr₃, ZrBr₄, ZrCl₄, ZrI₂, YBr, ZrBr₄, ZrCl₄, ZrI₄, NbCl₅, MoCl₃, MoCl₅, RuI₃, RhCl₃, PdBr₂, PdCl₂, PdI₂, AgCl, AgI, CdBr₂, CdCl₂, CdI₂, InBr, InBr₃, InCl, InCl₂, InCl₃, InI, InI₃, SnBr₂, SnCl₂, SnI₂, SnI₄, SnCl₃, SbI₃, CsBr, CsCl, CsI, BaCl₂, BaI₂, HfCl₄, TaCl₅, WCl₄, WCl₆, ReCl₃, ReCl₅, IrCl₃, PtBr₂, PtCl₂, AuBr₃, AuCl, AuCl₃, AuI, KAuCl₄, LaBr₃, LaCl₃, LaI₃, CeBr₃, CeCl₃, CeI₃, and mixtures thereof;
(iii) an oxometallate selected from the group consisting of LiIO₃, LiBO₂, Li₂SO₃, LiClO₄, Na₂B₄O₇, NaBO₃, Na₂SiO₃, NaVO₃, Na₂MoO₄, Na₂SeO₄, Na₂SeO₃, Na₂TeO₃, K₂SiO₃, K₂CrO₄, K₂Cr2O₇, CaSiO₃, BaMnO₄, and mixtures thereof; and
(iv) a metal carbonate selected from the group consisting of Li₂CO₃, Na₂CO₃, NaHCO₃, MgCO₃, K₂CO₃, CaCO₃, Cr₂(CO₃)₃, MnCO₃, CoCO₃, NiCO₃, CuCO₃, Rb₂CO₃, SrCO₃, Y₂(CO3)₃, Ag₂CO₃, CdCO₃, In₂(CO₃)₃, Sb₂(CO₃)₃, C₂CO₃, BaCO₃, La₂(CO₃)₃, Ce₂(CO₃)₃, NaAl(CO₃) (OH)₂, and mixtures thereof,
   with the proviso that the powdered flux composition does not contain a fluorine-containing compound.

In other embodiments the flux composition may contain at least one of a metal oxide, a metal halide, an oxometallate, and a metal carbonate—with the proviso that no metal fluoride is included. In other embodiments the flux composition may contain at least one of a metal oxide, a metal halide, an oxometallate, and a metal carbonate—with the proviso that at least one of Sc₂O₃, Cr₂O₃, Y₂O₃, ZrO₂, HfO₂, La₂O₃, Ce₂O₃, Al₂O₃ and CeO₂ is included. For example, in some embodiments the flux composition is required to contain at least 7.5 percent by weight of zirconia, relative to a total weight of the flux composition.

In some embodiments the flux composition may also contain certain organic fluxing agents. Examples of organic compounds exhibiting flux characteristics include high-molecular weight hydrocarbons (e.g., beeswax, paraffin), carbohydrates (e.g., cellulose), natural and synthetic oils (e.g., palm oil), organic reducing agents (e.g., charcoal, coke), carboxylic acids and dicarboxylic acids (e.g., abietic acid, isopimaric acid, neoabietic acid, dehydroabietic acid, rosins), carboxylic acid salts (e.g., rosin salts), carboxylic acid derivatives (e.g., dehydro-abietylamine), amines (e.g., triethanolamine), alcohols (e.g., high polyglycols, glycerols), natural and synthetic resins (e.g., polyol esters of fatty acids), mixtures of such compounds, and other organic compounds.

In some embodiments of the present invention, laser processing of reflective metals as described above may be performed under an atmosphere containing greater than 10 ppm of oxygen. For example, some embodiments may be conducted in air without the use of an externally-applied inert gas to deposit reflective metals largely free of the chemical and mechanical imperfections described above. Other embodiments may be performed under an inert gas atmosphere such as helium, nitrogen or argon, or in the presence of a flowing inert gas.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method, comprising heating a reflective metal by applying a laser beam to a layer of flux in contact with the reflective metal, wherein the flux is a powdered flux composition.

2. The method of claim 1, wherein a thickness of the layer of flux ranges from about 1 mm to about 10 mm.

3. The method of claim 1, wherein a particle size of the powdered flux composition ranges from about 0.005 mm to about 5 mm in diameter.

4. The method of claim 1, wherein a frequency of the laser beam is greater than 1 μm.

5. The method of claim 1, wherein the reflective metal is selected from the group consisting of copper, aluminum and silver.

6. The method of claim 1, wherein the reflective metal is in the form of a powdered filler material.

7. The method of claim 1, wherein the powdered flux composition comprises at least one of:
(i) a metal oxide;
(ii) a metal halide;
(iii) an oxometallate; and
(iv) a metal carbonate.

8. The method of claim 1, wherein the powdered flux composition comprises at least one of:
(i) a metal oxide selected from the group consisting of Li₂O, BeO, B₂O₃, B₆O, MgO, Al₂O₃, SiO₂, CaO, Sc₂O₃, TiO, TiO₂, Ti₂O₃, VO, V₂O₃, V₂O₄, V₂O₅, Cr₂O₃, CrO₃, MnO, MnO₂, Mn₂O₃, Mn₃O₄, FeO, Fe₂O₃, Fe₃O₄, CoO, Co₃O₄, NiO, Ni₂O₃, Cu₂O, CuO, ZnO, Ga₂O₃, GeO₂, As₂O₃, Rb₂O, SrO, Y₂O₃, ZrO₂, NiO, NiO₂, Ni₂O₅, MoO₃, MoO₂, RuO₂, Rh₂O₃, RhO₂, PdO, Ag₂O, CdO, In₂O₃, SnO, SnO₂, Sb₂O₃, TeO₂, TeO₃, Cs₂O, BaO, HfO₂, Ta₂O₅, WO₂, WO₃, ReO₃, Re₂O₇, PtO₂, Au₂O₃, La₂O₃, CeO₂, Ce₂O₃, and mixtures thereof;
(ii) a metal halide selected from the group consisting of LiF, LiCl, LiBr, LiI, Li₂NiBr₄, Li₂CuCl₄, LiAsF₆, LiPF₆, LiAlCl₄, LiGaCl₄, Li₂PdCl₄, NaF, NaCl, NaBr, Na₃AlF₆, NaSbF₆, NaAsF₆, NaAuBr₄, NaAlCl₄, Na₂PdCl₄, Na₂PtCl₄, MgF₂, MgCl₂, MgBr₂, AlF₃, KCl, KF, KBr, K₂RuCl₅, K₂IrCl₆, K₂PtCl₆, K₂PtCl₆, K₂ReCl₆, K₃RhCl₆, KSbF₆, KAsF₆, K₂NiF₆, K₂TiF₆, K₂ZrF₆, K₂PtI₆, KAuBr₄, K₂PdBr₄, K₂PdCl₄, CaF₂, CaF, CaBr₂, CaCl₂, CaI₂, ScBr₃, ScCl₃, ScF₃, ScI₃, TiF₃, VCl₂, VCl₃, CrCl₃, CrBr₃, CrCl₂, CrF₂, MnCl₂, MnBr₂, MnF₂, MnF₃, MnI₂, FeBr₂, FeBr₃, FeCl₂, FeCl₃, FeI₂, CoBr₂, CoCl₂, CoF₃, CoF₂, CoI₂, NiBr₂, NiCl₂, NiF₂, NiI₂, CuBr, CuBr₂, CuCl, CuCl₂, CuF₂, CuI, ZnF₂, ZnBr₂, ZnCl₂, ZnI₂, GaBr₃, Ga₂Cl₄, GaCl₃, GaF₃, GaI₃, GaBr₂, GeBr₂, GeI₂, GeI₄, RbBr, RbCl, RbF, RbI, SrBr₂, SrCl₂, SrF₂, SrI₂, YCl₃, YF₃, YI₃, YBr₃, ZrBr₄, ZrCl₄, ZrI₂, YBr, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, AgCl, AgF, AgF₂, AgSbF₆, AgI, CdBr₂, CdCl₂, CdI₂, InBr, InBr₃, InCl, InCl₂, InCl₃, InF₃, InI, InI₃, SnBr₂, SnCl₂, SnI₂, SnI₄, SnCl₃, SbF₃, SbI₃, CsBr, CsCl, CsF, CsI, BaCl₂, BaF₂, BaI₂, BaCoF₄, BaNiF₄, HfCl₄, HfF₄, TaCl₅, TaF₅, WCl₄, WCl₆, ReCl₃, ReCl₅, IrCl₃, PtBr₂, PtCl₂, AuBr₃, AuCl, AuCl₃, AuI, KAuCl₄, LaBr₃, LaCl₃, LaF₃, LaI₃, CeBr₃, CeCl₃, CeF₃, CeF₄, CeI₃, and mixtures thereof;
(iii) an oxometallate selected from the group consisting of LiIO₃, LiBO₂, Li₂SiO₃, LiClO₄, Na₂B₄O₇, NaBO₃, Na₂SiO₃, NaVO₃, Na₂MoO₄, Na₂SeO₄, Na₂SeO₃, Na₂TeO₃, K₂SiO₃, K₂CrO₄, K₂Cr2O₇, CaSiO₃, BaMnO₄, and mixtures thereof; and
(iv) a metal carbonate selected from the group consisting of Li₂CO₃, Na₂CO₃, NaHCO₃, MgCO₃, K₂CO₃, CaCO₃, Cr₂(CO₃)₃, MnCO₃, CoCO₃, NiCO₃, CuCO₃, Rb₂CO₃, SrCO₃, Y₂(CO3)₃, Ag₂CO₃, CdCO₃, In₂(CO₃)₃, Sb₂(CO₃)₃, C₂CO₃, BaCO₃, La₂(CO₃)₃, Ce₂(CO₃)₃, NaAl(CO₃) (OH)₂, and mixtures thereof.

9. The method of claim 1, wherein the powdered flux composition comprises:
(A) at least one selected from the group consisting of Sc₂O₃, Cr₂O₃, Y₂O₃, ZrO₂, HfO₂, La₂O₃, Ce₂O₃, Al₂O₃ and CeO₂; and
(B) at least one of:
(i) a metal oxide selected from the group consisting of Li₂O, BeO, B₂O₃, B₆O, MgO, SiO₂, CaO, TiO, Ti₂O₃, VO, V₂O₃, V₂O₄, V₂O₅, CrO₃, MnO, MnO₂, Mn₂O₃, Mn₃O₄, FeO, Fe₂O₃, Fe₃O₄, CoO, Co₃O₄, NiO, Ni₂O₃, Cu₂O, CuO, ZnO, Ga₂O₃, GeO₂, As₂O₃, Rb₂O, SrO, ZrO₂, NiO, NiO₂, Ni₂O₅, MoO₃, MoO₂, RuO₂, Rh₂O₃, RhO₂, PdO, Ag₂O, CdO, In₂O₃, SnO, SnO₂, Sb₂O₃, TeO₂, TeO₃, Cs₂O, BaO, Ta₂O₅, WO₂, WO₃, ReO₃, Re₂O₇, PtO₂, Au₂O₃, and mixtures thereof;
(ii) a metal halide selected from the group consisting of LiCl, LiBr, LiI, Li₂NiBr₄, Li₂CuCl₄, LiAlCl₄, LiGaCl₄, Li₂PdCl₄, NaCl, NaBr, NaAuBr₄, NaAlCl₄, Na₂PdCl₄, Na₂PtCl₄, MgCl₂, MgBr₂, KCl, KBr, K₂RuCl₅, K₂IrCl₆, K₂PtCl₆, K₂PtCl₆, K₂ReCl₆, K₃RhCl₆, K₂PtI₆, KAuBr₄, K₂PdBr₄, K₂PdCl₄, CaBr₂, CaCl₂, CaI₂, ScBr₃, ScCl₃, ScI₃, VCl₂, VCl₃, CrCl₃, CrBr₃, CrCl₂, MnCl₂, MnBr₂, MnI₂, FeBr₂, FeBr₃, FeCl₂, FeCl₃, FeI₂, CoBr₂, CoCl₂, CoI₂, NiBr₂, NiCl₂, NiI₂, CuBr, CuBr₂, CuCl, CuCl₂, CuI, ZnBr₂, ZnCl₂, ZnI₂, GaBr₃, Ga₂Cl₄, GaCl₃, GaI₃, GaBr₂, GeBr₂, GeI₂, GeI₄, RbBr, RbCl, RbI, SrBr₂, SrCl₂, SrI₂, YCl₃, YI₃, YBr₃, ZrBr₄, ZrCl₄, ZrI₂, YBr, ZrBr₄, ZrCl₄, ZrI₄, NbCl₅, MoCl₃, MoCl₅, RuI₃, RhCl₃, PdBr₂, PdCl₂, PdI₂, AgCl, AgI, CdBr₂, CdCl₂, CdI₂, InBr, InBr₃, InCl, InCl₂, InCl₃, InI, InI₃, SnBr₂, SnCl₂, SnI₂, SnI₄, SnCl₃, SbI₃, CsBr, CsCl, CsI, BaCl₂, BaI₂, HfCl₄, TaCl₅, WCl₄, WCl₆, ReCl₃, ReCl₅, IrCl₃, PtBr₂, PtCl₂, AuBr₃, AuCl, AuCl₃, AuI, KAuCl₄, LaBr₃, LaCl₃, LaI₃, CeBr₃, CeCl₃, CeI₃, and mixtures thereof;
(iii) an oxometallate selected from the group consisting of LiIO₃, LiBO₂, Li₂SO₃, LiClO₄, Na₂B₄O₇, NaBO₃, Na₂SiO₃, NaVO₃, Na₂MoO₄, Na₂SeO₄, Na₂SeO₃, Na₂TeO₃, K₂SiO₃, K₂CrO₄, K₂Cr2O₇, CaSiO₃, BaMnO₄, and mixtures thereof; and
(iv) a metal carbonate selected from the group consisting of Li₂CO₃, Na₂CO₃, NaHCO₃, MgCO₃, K₂CO₃, CaCO₃, Cr₂(CO₃)₃, MnCO₃, CoCO₃, NiCO₃, CuCO₃, Rb₂CO₃, SrCO₃, Y₂(CO3)₃, Ag₂CO₃, CdCO₃, In₂(CO₃)₃, Sb₂(CO₃)₃, C₂CO₃, BaCO₃, La₂(CO₃)₃, Ce₂(CO₃)₃, NaAl(CO₃) (OH)₂, and mixtures thereof,
with the proviso that the powdered flux composition does not contain a fluorine-containing compound.

10. The method of claim 1, wherein the heating does not occur under an inert gas atmosphere.

11. The method of claim 1, further comprising controlling a heating rate of the reflective metal by directing a plasma suppression gas over a heated surface of the layer of flux in order to displace a plasma generated by the laser beam.

12. A method, comprising:
applying a laser beam to a powdered flux composition in contact with a reflective metal such that thermal energy absorbed from the laser beam by the flux composition is transferred to the reflective metal to form a melt pool; and
allowing the melt pool to cool and solidify into a metal layer covered by a slag layer.

13. The method of claim 12, wherein a particle size of the powdered flux composition ranges from about 0.005 mm to about 5 mm in diameter.

14. The method of claim 12, wherein a frequency of the laser beam is greater than 1 μm.

15. The method of claim 12, wherein the reflective metal is selected from the group consisting of copper, aluminum and silver.

16. The method of claim 12, wherein:
the powdered flux composition is in the form of a separate flux layer covering a layer of a filler material comprising the reflective metal; and
a thickness of the separate flux layer ranges from about 1 mm to about 10 mm.

17. The method of claim 12, wherein the powdered flux composition comprises at least one of:
(i) a metal oxide;
(ii) a metal halide;
(iii) an oxometallate; and
(iv) a metal carbonate.

18. The method of claim 12, wherein the powdered flux composition comprises:
(A) at least one selected from the group consisting of Sc₂O₃, Cr₂O₃, Y₂O₃, ZrO₂, HfO₂, La₂O₃, Ce₂O₃, Al₂O₃ and CeO₂; and
(B) at least one of:
(i) a metal oxide selected from the group consisting of Li₂O, BeO, B₂O₃, B₆O, MgO, SiO₂, CaO, TiO, Ti₂O₃, VO, V₂O₃, V₂O₄, V₂O₅, CrO₃, MnO, MnO₂, Mn₂O₃, Mn₃O₄, FeO, Fe₂O₃, Fe₃O₄, CoO, Co₃O₄, NiO, Ni₂O₃, Cu₂O, CuO, ZnO, Ga₂O₃, GeO₂, As₂O₃, Rb₂O, SrO, ZrO₂, NiO, NiO₂, Ni₂O₅, MoO₃, MoO₂, RuO₂, Rh₂O₃, RhO₂, PdO, Ag₂O, CdO, In₂O₃, SnO, SnO₂, Sb₂O₃, TeO₂, TeO₃, Cs₂O, BaO, Ta₂O₅, WO₂, WO₃, ReO₃, Re₂O₇, PtO₂, Au₂O₃, and mixtures thereof;
(ii) a metal halide selected from the group consisting of LiCl, LiBr, LiI, Li₂NiBr₄, Li₂CuCl₄, LiAlCl₄, LiGaCl₄, Li₂PdCl₄, NaCl, NaBr, NaAuBr₄, NaAlCl₄, Na₂PdCl₄, Na₂PtCl₄, MgCl₂, MgBr₂, KCl, KBr, K₂RuCl₅, K₂IrCl₆, K₂PtCl₆, K₂PtCl₆, K₂ReCl₆, K₃RhCl₆, K₂PtI₆, KAuBr₄, K₂PdBr₄, K₂PdCl₄, CaBr₂, CaCl₂, CaI₂, ScBr₃, ScCl₃, ScI₃, VCl₂, VCl₃, CrCl₃, CrBr₃, CrCl₂, MnCl₂, MnBr₂, MnI₂, FeBr₂, FeBr₃, FeCl₂, FeCl₃, FeI₂, CoBr₂, CoCl₂, CoI₂, NiBr₂, NiCl₂, NiI₂, CuBr, CuBr₂, CuCl, CuCl₂, CuI, ZnBr₂, ZnCl₂, ZnI₂, GaBr₃, Ga₂Cl₄, GaCl₃, GaI₃, GaBr₂, GeBr₂, GeI₂, GeI₄, RbBr, RbCl, RbI, SrBr₂, SrCl₂, SrI₂, YCl₃, YI₃, YBr₃, ZrBr₄, ZrCl₄, ZrI₂, YBr, ZrBr₄, ZrCl₄, ZrI₄, NbCl₅, MoCl₃, MoCl₅, RuI₃, RhCl₃, PdBr₂, PdCl₂, PdI₂, AgCl, AgI, CdBr₂, CdCl₂, CdI₂, InBr, InBr₃, InCl, InCl₂, InCl₃, InI, InI₃, SnBr₂, SnCl₂, SnI₂, SnI₄, SnCl₃, SbI₃, CsBr, CsCl, CsI, BaCl₂, BaI₂, HfCl₄, TaCl₅, WCl₄, WCl₆, ReCl₃, ReCl₅, IrCl₃, PtBr₂, PtCl₂, AuBr₃, AuCl, AuCl₃, AuI, KAuCl₄, LaBr₃, LaCl₃, LaI₃, CeBr₃,
(iii) an oxometallate selected from the group consisting of LiIO₃, LiBO₂, Li₂SO₃, LiClO₄, Na₂B₄O₇, NaBO₃, Na₂SiO₃, NaVO₃, Na₂MoO₄, Na₂SeO₄, Na₂SeO₃, Na₂TeO₃, K₂SiO₃, K₂CrO₄, K₂Cr2O₇, CaSiO₃, BaMnO₄, and mixtures thereof; and
(iv) a metal carbonate selected from the group consisting of Li₂CO₃, Na₂CO₃, NaHCO₃, MgCO₃, K₂CO₃, CaCO₃, Cr₂(CO₃)₃, MnCO₃, CoCO₃, NiCO₃, CuCO₃, Rb₂CO₃, SrCO₃, Y₂(CO3)₃, Ag₂CO₃, CdCO₃, In₂(CO₃)₃, Sb₂(CO₃)₃, C₂CO₃, BaCO₃, La₂(CO₃)₃, Ce₂(CO₃)₃, NaAl(CO₃) (OH)₂, and mixtures thereof,
with the proviso that the powdered flux composition does not contain a fluorine-containing compound.

19. The method of claim 12, further comprising injecting strengthening particles into the melt pool, such that the metal layer is a dispersion strengthened metal layer, wherein the strengthening particles comprise at least one selected from the group consisting of a metal oxide, a metal carbide and the metal nitride.

20. The method of claim 12, wherein the cooling of the melt pool occurs with directional control of heat transfer in a manner effective to control a geometric shape of resulting grain structures in the metal layer.
